(19) United States
(12) Patent Application Publication
(10) Pub. No.: US 2026/0039207 A1
(43) Pub. Date: Feb. 5, 2026

(54) POWER CONVERSION DEVICE

(71) Applicant: KABUSHIKI KAISHA TOSHIBA, Tokyo (JP)

(72) Inventors: Keigo ARITA, Kawasaki Kanagawa (JP); Tatsunori SAKANO, Shinagawa Tokyo (JP)

(73) Assignee: KABUSHIKI KAISHA TOSHIBA, Tokyo (JP)

(21) Appl. No.: 19/221,685

(22) Filed: May 29, 2025

(30) Foreign Application Priority Data
Jul. 31, 2024 (JP) 2024-124342

(51) Int. Cl. H02M 3/335; H02M 3/00

(52) U.S. Cl. CPC H02M 3/3353; H02M 3/01

(57) ABSTRACT

A power conversion device includes a voltage generation circuit configured to generate an alternating current voltage having N phases, N being a positive multiple of 3; a rectifying circuit; and N resonant circuits connected between the voltage generation circuit and the rectifying circuit. The resonant circuits are connected in series with each other. Each of the resonant circuits includes a first capacitor, a second capacitor, a coupled inductor including a first core, a first winding wound around the first core and connected in series with the first capacitor, a second winding wound around the first core and connected in series with the second capacitor, and a parallel inductor including a third winding connected between the first winding and the second winding.

### CROSS-REFERENCE TO RELATED APPLICATION

This application is based upon and claims the benefit of priority from Japanese Patent Application No. 2024-124342, filed on Jul. 31, 2024; the entire contents of which are incorporated herein by reference.

### FIELD

Embodiments described herein relate generally to a power conversion device.

### BACKGROUND

A capacitor-isolated LLC resonant converter is known.

### BRIEF DESCRIPTION OF THE DRAWINGS

FIG. 1 is a circuit diagram of a power conversion device of an embodiment;

FIG. 2 is a schematic view of a coupled inductor of the embodiment;

FIG. 3 is an equivalent circuit diagram of the coupled inductor of the embodiment;

FIG. 4 is a circuit diagram of a resonant circuit of a third comparative example;

FIG. 5 is a circuit diagram of a resonant circuit of the embodiment;

FIG. 6A is a waveform diagram of a resonant current of the resonant circuit of the third comparative example, and FIG. 6B is a waveform diagram of a resonant current of the resonant circuit of the embodiment; and

FIG. 7A to FIG. 8B are circuit diagrams showing modifications of the resonant circuit of the embodiment.

### DETAILED DESCRIPTION

According to one embodiment, a power conversion device includes a voltage generation circuit configured to generate an alternating current voltage having N phases, N being a positive multiple of 3; a rectifying circuit; and N resonant circuits connected between the voltage generation circuit and the rectifying circuit, the resonant circuits being connected in series with each other, each of the resonant circuits including a first capacitor, a second capacitor, a coupled inductor including a first core, a first winding wound around the first core and connected in series with the first capacitor, a second winding wound around the first core and connected in series with the second capacitor, and a parallel inductor including a third winding connected between the first winding and the second winding.

Exemplary embodiments will now be described with reference to the drawings.

The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

In the specification of the application and the drawings, components similar to those described in regard to a drawing thereinabove are marked with like reference numerals, and a detailed description is omitted as appropriate.

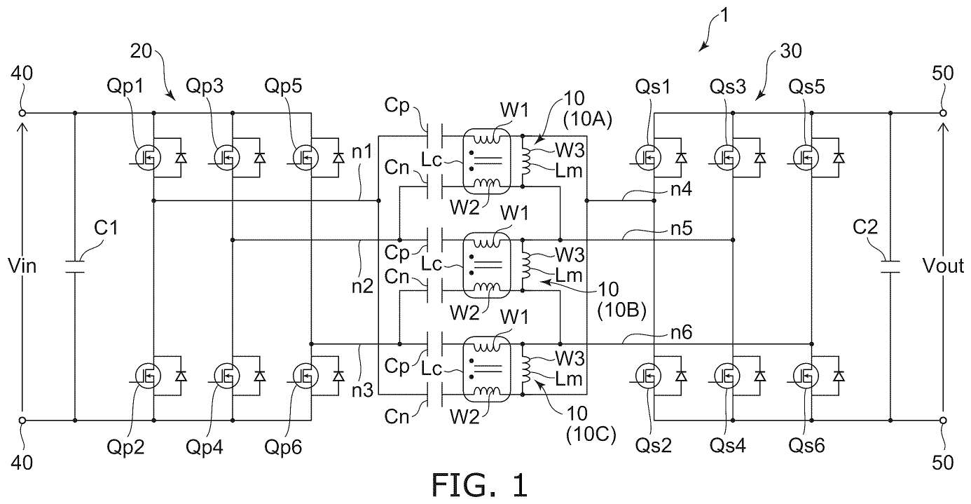

FIG. 1 is a circuit diagram of a power conversion device 1 of an embodiment. The power conversion device 1 of the embodiment includes a voltage generation circuit 20 that generates an AC voltage having N phases (N being a positive multiple of 3), a rectifying circuit 30, and N resonant circuits 10 connected between the voltage generation circuit 20 and the rectifying circuit 30.

The power conversion device 1 of the embodiment is a capacitor-isolated (or electric-field-coupled) LLC resonant converter in which the voltage generation circuit 20 at the input side and the rectifying circuit 30 at the output side are electrically insulated by first capacitors Cp and second capacitors Cn. The embodiment describes a capacitor-isolated LLC resonant converter that transmits power by using three-phase alternating current as N-phase alternating current.

A DC voltage Vin is input to input terminals 40 of the voltage generation circuit 20; and the voltage generation circuit 20 outputs a three-phase AC voltage. The output of the voltage generation circuit 20 is transmitted to the rectifying circuit 30 at the output side as three-phase AC power by the resonant operation of the three resonant circuits 10. The rectifying circuit 30 rectifies the three-phase AC power and outputs a DC voltage Vout to output terminals 50.

The voltage generation circuit 20 includes three output nodes (a first output node n1, a second output node n2, and a third output node n3) that output the three-phase AC voltage. The voltage generation circuit 20 is, for example, an inverter circuit and includes an input capacitor C1, a first input-side semiconductor element Qp1, a second input-side semiconductor element Qp2, a third input-side semiconductor element Qp3, a fourth input-side semiconductor element Qp4, a fifth input-side semiconductor element Qp5, and a sixth input-side semiconductor element Qp6.

The first input-side semiconductor element Qp1 and the second input-side semiconductor element Qp2 are connected in series. The third input-side semiconductor element Qp3 and the fourth input-side semiconductor element Qp4 are connected in series. The fifth input-side semiconductor element Qp5 and the sixth input-side semiconductor element Qp6 are connected in series. The pair of the first and second input-side semiconductor elements Qp1 and Qp2 connected in series, the pair of the third and fourth input-side semiconductor elements Qp3 and Qp4 connected in series, and the pair of the fifth and sixth input-side semiconductor elements Qp5 and Qp6 connected in series are connected in parallel with the input terminals 40. The first output node n1 is connected between the first input-side semiconductor element Qp1 and the second input-side semiconductor element Qp2. The second output node n2 is connected between the third input-side semiconductor element Qp3 and the fourth input-side semiconductor element Qp4. The third output node n3 is connected between the fifth input-side semiconductor element Qp5 and the sixth input-side semiconductor element Qp6.

The first input-side semiconductor element Qp1 and the second input-side semiconductor element Qp2 output a sinusoidal voltage to the first output node n1 by being alternately switched on and off. The third input-side semiconductor element Qp3 and the fourth input-side semiconductor element Qp4 output a sinusoidal voltage to the second output node n2 by being alternately switched on and off. The fifth input-side semiconductor element Qp5 and the sixth input-side semiconductor element Qp6 output a sinusoidal voltage to the third output node n3 by being alternately switched on and off. The phase of the sinusoidal voltage output to the first output node n1, the phase of the sinusoidal voltage output to the second output node n2, and the phase of the sinusoidal voltage output to the third output node n3 each are shifted 120°.

Each pair of input-side semiconductor elements that are alternately switched on and off has a period (a dead time) in which both elements of the pair of input-side semiconductor elements are switched off. The first input-side semiconductor element Qp1 and the second input-side semiconductor element Qp2 which are alternately switched on and off have a period in which both the first and second input-side semiconductor elements Qp1 and Qp2 are switched off. The third input-side semiconductor element Qp3 and the fourth input-side semiconductor element Qp4 which are alternately switched on and off have a period in which both the third and fourth input-side semiconductor elements Qp3 and Qp4 are switched off. The fifth input-side semiconductor element Qp5 and the sixth input-side semiconductor element Qp6 which are alternately switched on and off have a period in which both the fifth and sixth input-side semiconductor elements Qp5 and Qp6 are switched off.

The power conversion device 1 includes the three resonant circuits 10 corresponding to the three-phase AC voltage generated by the voltage generation circuit 20. The three resonant circuits 10 are taken as a first resonant circuit 10A, a second resonant circuit 10B, and a third resonant circuit 10C. The first resonant circuit 10A, the second resonant circuit 10B, and the third resonant circuit 10C may be referred to as simply the resonant circuit 10 without differentiating.

The first resonant circuit 10A, the second resonant circuit 10B, and the third resonant circuit 10C are connected in series with each other. In this case, the first resonant circuit 10A, the second resonant circuit 10B, and the third resonant circuit 10C have a Δ-connection.

The first resonant circuit 10A, the second resonant circuit 10B, and the third resonant circuit 10C each include the first capacitor Cp, the second capacitor Cn, a coupled inductor Lc, and a parallel inductor (an excitation inductor) Lm.

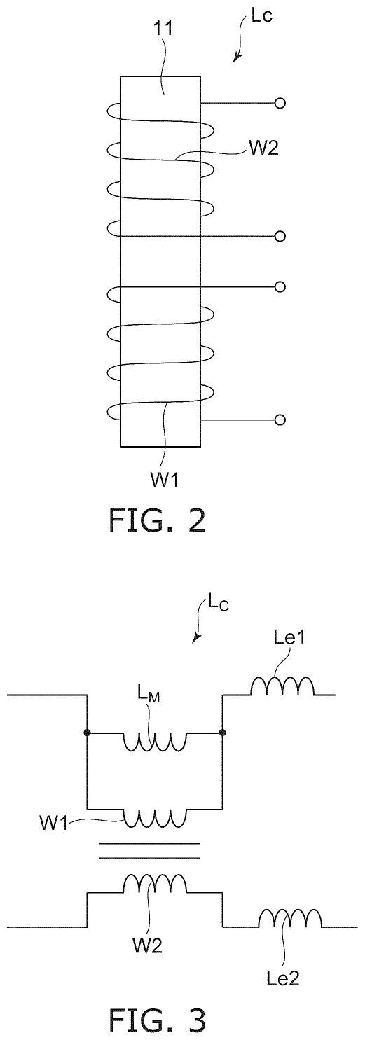

As shown in FIG. 2, the coupled inductor Lc includes a first core 11, a first winding W1 wound around the first core 11, and a second winding W2 wound around the first core 11. The first winding W1 and the second winding W2 are magnetically coupled via the first core 11. The first winding W1 and the second winding W2 are electrically connected. For example, copper wires can be used as the first winding W1 and the second winding W2. The first core 11 is a magnetic body. For example, a MnZn ferrite or the like can be used as the magnetic body of the first core 11.

FIG. 3 is an equivalent circuit diagram of the coupled inductor Lc of the embodiment. In addition to an excitation inductance L_{M} that generates the main magnetic flux, the coupled inductor Lc includes a leakage inductance Le1 generated by the leakage flux of the first winding W1 side, and a leakage inductance Le2 generated by the leakage flux of the second winding W2 side. The main magnetic flux is linked with both the first and second windings W1 and W2. The leakage flux of the first winding W1 side is linked only with the first winding W1, and is not linked with the second winding W2. The leakage flux of the second winding W2 side is linked only with the second winding W2, and is not linked with the first winding W1. The leakage inductance Le1 and the leakage inductance Le2 function as resonant inductors of each resonant circuit 10. As a result, the resonant circuit can be smaller than a configuration in which resonant inductors are included as components separate from the coupled inductor Lc.

In the example shown in FIG. 1, the coupled inductor Lc is connected between the first capacitor Cp and the parallel inductor Lm and between the second capacitor Cn and the parallel inductor Lm. The first capacitor Cp is connected in series with the first winding W1. The second capacitor Cn is connected in series with the second winding W2.

The parallel inductor Lm includes a third winding W3 connected between the first winding W1 and the second winding W2. For example, a copper wire can be used as the third winding W3. The parallel inductor Lm may include a second core around which the third winding W3 is wound.

The first and second capacitors Cp and Cn of each resonant circuit 10 are connected respectively to mutually-different output nodes.

The first capacitor Cp of the first resonant circuit 10A is connected between the first output node n1 of the voltage generation circuit 20 and the first winding W1 of the first resonant circuit 10A. The second capacitor Cn of the first resonant circuit 10A is connected between the second output node n2 of the voltage generation circuit 20 and the second winding W2 of the first resonant circuit 10A.

The first capacitor Cp of the second resonant circuit 10B is connected between the second output node n2 of the voltage generation circuit 20 and the first winding W1 of the second resonant circuit 10B. The second capacitor Cn of the second resonant circuit 10B is connected between the third output node n3 of the voltage generation circuit 20 and the second winding W2 of the second resonant circuit 10B.

The first capacitor Cp of the third resonant circuit 10C is connected between the third output node n3 of the voltage generation circuit 20 and the first winding W1 of the third resonant circuit 10C. The second capacitor Cn of the third resonant circuit 10C is connected between the first output node n1 of the voltage generation circuit 20 and the second winding W2 of the third resonant circuit 10C.

In the coupled inductors Lc of the first resonant circuit 10A, the second resonant circuit 10B, and the third resonant circuit 10C, a number of turns N₁ of the first winding W1 and a number of turns N₂ of the second winding W2 are equal.

The rectifying circuit 30 includes three input nodes (a first input node n4, a second input node n5, and a third input node n6) to which the outputs of the resonant circuits 10 are input. The first winding W1 of the first resonant circuit 10A and the second winding W2 of the third resonant circuit 10C are connected to the first input node n4. The second winding W2 of the first resonant circuit 10A and the first winding W1 of the second resonant circuit 10B are connected to the second input node n5. The second winding W2 of the second resonant circuit 10B and the first winding W1 of the third resonant circuit 10C are connected to the third input node n6.

The rectifying circuit 30 is, for example, a three-phase rectifying circuit utilizing switching of semiconductor elements as rectifying elements, and includes a first output-side semiconductor element Qs1, a second output-side semiconductor element Qs2, a third output-side semiconductor element Qs3, a fourth output-side semiconductor element Qs4, a fifth output-side semiconductor element Qs5, a sixth output-side semiconductor element Qs6, and a smoothing capacitor C2. The rectifying circuit 30 may be configured using diodes as the rectifying elements. The loss of the rectifying circuit 30 is easily reduced by utilizing the switching of semiconductor elements.

The first output-side semiconductor element Qs1 and the second output-side semiconductor element Qs2 are connected in series. The third output-side semiconductor element Qs3 and the fourth output-side semiconductor element Qs4 are connected in series. The fifth output-side semiconductor element Qs5 and the sixth output-side semiconductor element Qs6 are connected in series. The pair of the first and second output-side semiconductor elements Qs1 and Qs2 connected in series, the pair of the third and fourth output-side semiconductor elements Qs3 and Qs4 connected in series, and the pair of the fifth and sixth output-side semiconductor elements Qs5 and Qs6 connected in series are connected in parallel with the output terminals 50. The first input node n4 is connected between the first output-side semiconductor element Qs1 and the second output-side semiconductor element Qs2. The second input node n5 is connected between the third output-side semiconductor element Qs3 and the fourth output-side semiconductor element Qs4. The third input node n6 is connected between the fifth output-side semiconductor element Qs5 and the sixth output-side semiconductor element Qs6.

Rectification is performed by the first output-side semiconductor element Qs1 and the second output-side semiconductor element Qs2 being alternately switched on and off by the orientation of the AC voltage flowing through the first input node n4. Rectification is performed by the third output-side semiconductor element Qs3 and the fourth output-side semiconductor element Qs4 being alternately switched on and off by the orientation of the AC voltage flowing through the second input node n5. Rectification is performed by the fifth output-side semiconductor element Qs5 and the sixth output-side semiconductor element Qs6 being alternately switched on and off by the orientation of the AC voltage flowing through the third input node n6.

Each pair of output-side semiconductor elements that are alternately switched on and off has a period (a dead time) in which both elements of the pair of output-side semiconductor elements are switched off. The first output-side semiconductor element Qs1 and the second output-side semiconductor element Qs2 which are alternately switched on and off have a period in which both the first and second output-side semiconductor elements Qs1 and Qs2 are switched off. The third output-side semiconductor element Qs3 and the fourth output-side semiconductor element Qs4 which are alternately switched on and off have a period in which both the third and fourth output-side semiconductor elements Qs3 and Qs4 are switched off. The fifth output-side semiconductor element Qs5 and the sixth output-side semiconductor element Qs6 which are alternately switched on and off have a period in which both the fifth and sixth output-side semiconductor elements Qs5 and Qs6 are switched off.

According to the embodiment, the power conversion device can be smaller than a transformer-isolated power conversion device because the voltage generation circuit 20 at the input side and the rectifying circuit 30 at the output side are isolated using the first capacitors Cp and the second capacitors Cn without using transformers.

The power conversion device 1 of the embodiment is an LLC resonant converter that transmits power with multi-phase (in the example, three-phase) alternating current, which makes it possible to increase the power density and efficiency compared to a single-phase LLC resonant converter.

A three-phase transformer-isolated LLC resonant converter may be considered as a first comparative example. The LLC resonant converter of the first comparative example includes three resonant circuits connected in series with each other. Each resonant circuit includes one capacitor, one resonant inductor, and one parallel inductor, and is magnetically coupled with the output-side rectifying circuit via a transformer.

Losses of the power conversion device 1 of the embodiment and the LLC resonant converter of the first comparative example above were compared by simulation by using simplified designs having the same specifications (input and output voltages of 384 V and an output of 10.8 kW). When the design conditions were set so that the component volume (187 cm³) of the power conversion device 1 of the embodiment and the component volume (198 cm³) of the LLC resonant converter of the first comparative example were substantially equal, the loss of the LLC resonant converter of the first comparative example was 146 W, whereas the loss of the power conversion device 1 of the embodiment was 67 W, and a loss reduction of 54% compared to the first comparative example can be expected.

A second comparative example may be considered in which the capacity of the LLC resonant converter is increased by using a configuration in which three single-phase LLC resonant converters are connected in parallel. In the second comparative example, it is necessary to connect voltage generation circuits respectively to the three resonant circuits; and the number of semiconductor elements in the voltage generation circuits is increased. Similarly, it is necessary to connect rectifying circuits respectively to the three resonant circuits; and the number of rectifying elements in the rectifying circuits is increased.

According to the embodiment, a three-phase LLC resonant converter is realized by connecting the three resonant circuits 10 in series (with a Δ-connection); and the number of semiconductor elements of the voltage generation circuit 20 and the number of rectifying elements of the rectifying circuit 30 can be fewer than those of the second comparative example. Also, the smoothing capacitor C2 of the rectifying circuit 30 can be smaller.

Component volumes of the power conversion device 1 of the embodiment and the LLC resonant converter of the second comparative example were compared by simulation by using simplified designs having the same specifications (input and output voltages of 384 V and an output of 10.8 kW).

When the design conditions were set so that the loss (65 W) of the power conversion device 1 of the embodiment and the loss (66 W) of the LLC resonant converter of the second comparative example were substantially equal, the component volume of the LLC resonant converter of the second comparative example was 300 cm³, whereas the component volume of the power conversion device 1 of the embodiment was 263 cm³, and a component volume reduction of 12% compared to the second comparative example can be expected.

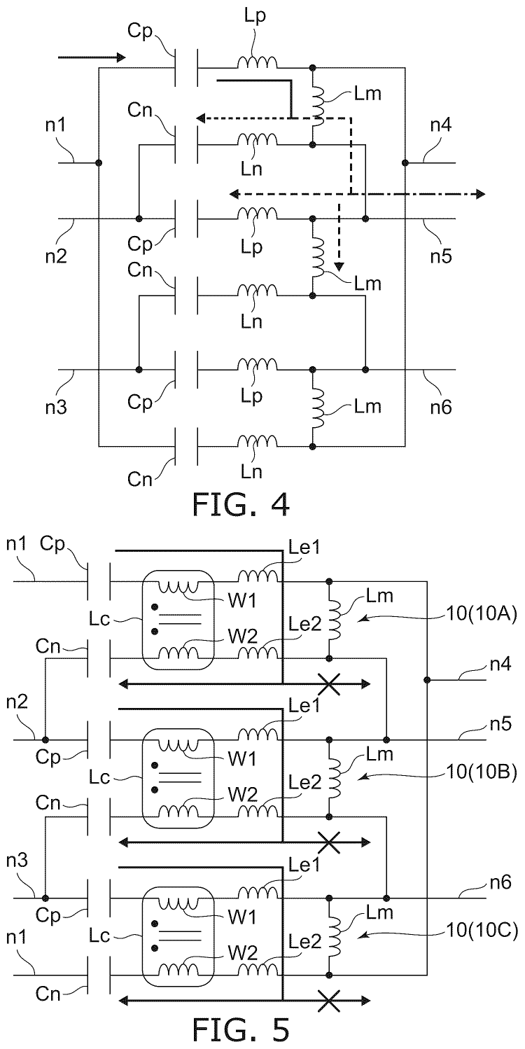

FIG. 4 is a circuit diagram of resonant circuits of a third comparative example configured for three phases. In the third comparative example, the three resonant circuits are connected in series (with a Δ-connection). Each resonant circuit includes the first capacitor Cp, a first resonant inductor Lp connected in series with the first capacitor Cp, the second capacitor Cn, a second resonant inductor Ln connected in series with the second capacitor Cn, and the parallel inductor Lm connected between the first resonant inductor Lp and the second resonant inductor Ln. The resonant circuits of the third comparative example do not include coupled inductors.

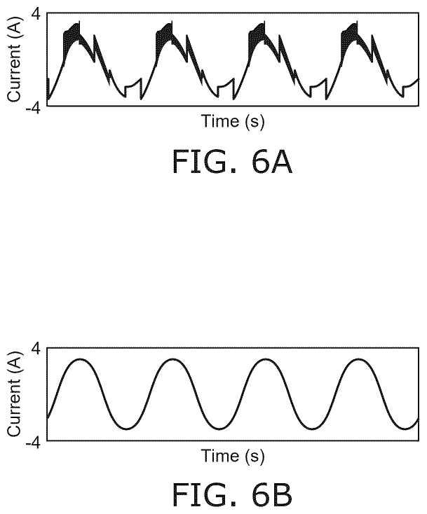

When capacitor-isolated, the capacitors that perform the isolating have lower impedances than transformers; therefore, if the resonant circuits are simply arranged for three phases in a capacitor-isolated configuration as in the third comparative example, a current path that interferes with the resonant circuits of the other phases is undesirably formed. FIG. 6A is a waveform diagram of a simulation of a resonant current flowing through one resonant circuit of the third comparative example. According to the third comparative example as shown in FIG. 6A, much LC resonance is observed, and an LLC converter operation cannot be realized.

In contrast, according to the embodiment as shown in FIG. 5, the coupled inductor Lc is used in each resonant circuit 10. In the coupled inductor Lc, the voltage applied to the first winding W1 is taken as V₁, the current flowing in the first winding W1 is taken as i₁, the number of turns of the first winding W1 is taken as N₁, the voltage applied to the second winding W2 is taken as V₂, the current flowing in the second winding W2 is taken as i₂, and the number of turns of the second winding W2 is taken as N₂. From the law of energy conservation, V₁i₁=V₂i₂=(N₂/N₁)V₁i₂. When N₁=N₂, i₁=i₂. Accordingly, due to the law of energy conservation, the currents that flow through the resonant circuits 10 are uniquely determined so that in each resonant circuit 10, the current flowing through the first winding W1 and the first resonant inductor (in the example, the leakage inductance Le1) and the current flowing through the second winding W2 and the second resonant inductor (in the example, the leakage inductance Le2) are equal. As a result, a current that interferes with the resonant circuits 10 of the other phases does not flow or can be reduced, and so the resonant circuits 10 of the phases can form independent current paths.

FIG. 6B is a waveform diagram of a simulation of the resonant current flowing through one resonant circuit 10 according to an embodiment. According to the embodiment as shown in FIG. 6B, a sinusoidal resonant current can be obtained, and a three-phase LLC converter operation can be realized.

The generation of a current that interferes with the other phases can be acceptable as long as the realization of the LLC converter operation is not obstructed. Therefore, in each coupled inductor Lc of the first resonant circuit 10A, the second resonant circuit 10B, and the third resonant circuit 10C, the number of turns N₁ of the first winding W1 and the number of turns N₂ of the second winding W2 are not limited to being exactly equal; and the ratio N₂/N₁ of the number of turns N₂ of the second winding W2 to the number of turns N₁ of the first winding W1 may be not less than 0.7 and not more than 1.3.

In a capacitor-isolated LLC converter, common mode noise that is generated at the input side tends to leak to the output side. According to the embodiment, by using the coupled inductor Lc in the resonant circuit 10, the resonance point of the common mode impedance is shifted toward the low-frequency side from the switching frequency of the resonant circuit; and the common mode impedance at the switching frequency is increased. As a result, leaking of the common mode noise from the input side to the output side can be suppressed.

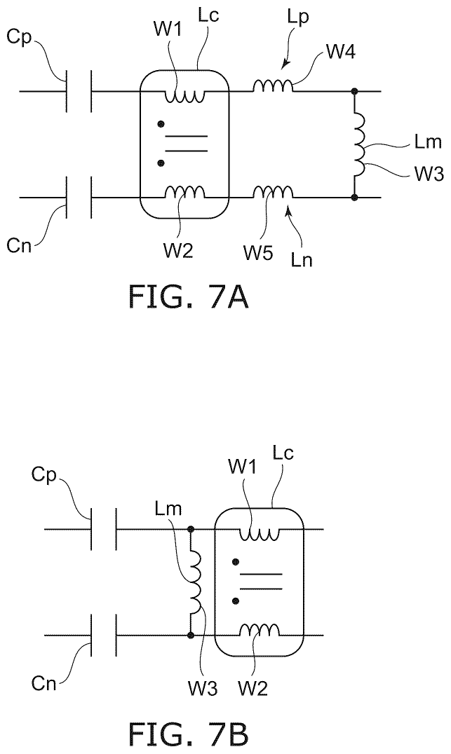

According to a first modification shown in FIG. 7A, the resonant circuit includes the first resonant inductor Lp and the second resonant inductor Ln as components separate from the coupled inductor Lc. The first resonant inductor Lp includes a fourth winding W4 connected between the first winding W1 of the coupled inductor Lc and the third winding W3 of the parallel inductor Lm. The first resonant inductor Lp may further include a third core around which the fourth winding W4 is wound. The second resonant inductor Ln includes a fifth winding W5 connected between the second winding W2 of the coupled inductor Lc and the third winding W3 of the parallel inductor Lm. The second resonant inductor Ln may further include a fourth core around which the fifth winding W5 is wound.

As in a second modification shown in FIG. 7B, the parallel inductor Lm may be connected between the first capacitor Cp and the first winding W1 and between the second capacitor Cn and the second winding W2.

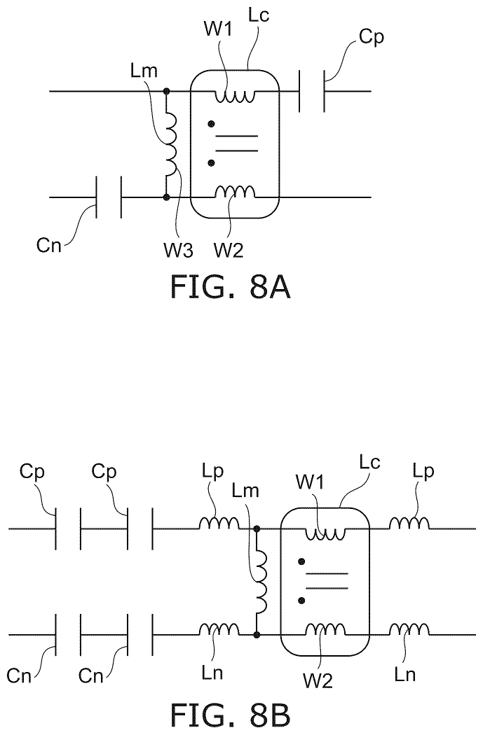

As in a third modification shown in FIG. 8A, the connection order (the arrangement order) of the first capacitor Cp, the first winding W1, and the parallel inductor Lm in the current path in which the first capacitor Cp and the first winding W1 are connected in series and the connection order (the arrangement order) of the second capacitor Cn, the second winding W2, and the parallel inductor Lm in the current path in which the second capacitor Cn and the second winding W2 are connected in series may be different. In the example shown in FIG. 8A, the first winding W1 is connected between the parallel inductor Lm and the first capacitor Cp; and the parallel inductor Lm is connected between the second capacitor Cn and the second winding W2.

It is favorable for the connection order of the first capacitor Cp, the first winding W1, and the parallel inductor Lm between the voltage generation circuit 20 and the rectifying circuit 30 and the connection order of the second capacitor Cn, the second winding W2, and the parallel inductor Lm between the voltage generation circuit 20 and the rectifying circuit 30 to be the same. As a result, it is easier to design the desired phase characteristics. Also, the generation of noise can be suppressed.

As in a fourth modification shown in FIG. 8B, the resonant circuit may include multiple first capacitors Cp. The resonant circuit may include multiple second capacitors Cn. The resonant circuit may include multiple first resonant inductors Lp. The resonant circuit may include multiple second resonant inductors Ln.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A power conversion device, comprising:
a voltage generation circuit configured to generate an alternating current voltage having N phases, N being a positive multiple of 3;
a rectifying circuit; and
N resonant circuits connected between the voltage generation circuit and the rectifying circuit, the resonant circuits being connected in series with each other,
each of the resonant circuits including
a first capacitor,
a second capacitor,
a coupled inductor including
a first core,
a first winding wound around the first core and connected in series with the first capacitor,
a second winding wound around the first core and connected in series with the second capacitor, and
a parallel inductor including a third winding connected between the first winding and the second winding.

2. The device according to claim 1, wherein
a number of turns of the first winding and a number of turns of the second winding are equal.

3. The device according to claim 1, wherein
a ratio N₂/N₁ of a number of turns N₂ of the second winding to a number of turns N₁ of the first winding is not less than 0.7 and not more than 1.3.

4. The device according to claim 1, wherein
each of the resonant circuits further includes:
a first resonant inductor including a fourth winding connected between the first winding and the third winding; and
a second resonant inductor including a fifth winding connected between the second winding and the third winding.

5. The device according to claim 1, wherein
the voltage generation circuit includes N output nodes, and
in each resonant circuit among the N resonant circuits, the first capacitor and the second capacitor are connected respectively to mutually-different output nodes among the N output nodes.

6. The device according to claim 1, wherein
a connection order of the first capacitor, the first winding, and the parallel inductor between the voltage generation circuit and the rectifying circuit and a connection order of the second capacitor, the second winding, and the parallel inductor between the voltage generation circuit and the rectifying circuit are the same.

7. The device according to claim 1, wherein
the voltage generation circuit includes N pairs of input-side semiconductor elements configured to be alternately switched on and off.

8. The device according to claim 7, wherein
each of the pairs of input-side semiconductor elements has a period in which both input-side semiconductor elements of the pair of input-side semiconductor elements are switched off.

9. The device according to claim 1, wherein
the rectifying circuit includes N pairs of output-side semiconductor elements configured to be alternately switched on and off.
